(19) United States
(12) Patent Application Publication
(10) Pub. No.: US 2013/0268436 A1
(43) Pub. Date: Oct. 10, 2013

(54) Common Service Platform System and Revenue Method

(71) Applicant: SCUINT CORPORATION, Austin, TX (US)

(72) Inventor: Steven B. Snidow, Austin, TX (US)

(73) Assignee: Scuint Corporation, Austin, TX (US)

(21) Appl. No.: 13/854,949

(22) Filed: Apr. 1, 2013

Related U.S. Application Data
(60) Provisional application No. 61/618,835, filed on Apr. 1, 2012.

(51) Int. Cl. G08C 13/02; G06Q 50/16

(52) U.S. Cl. CPC G08C 13/02; G06Q 50/16
USPC 705/40; 705/311; 340/870.07

(57) ABSTRACT

A business method to provide and charge for utility, digital and analog services from a common service platform system to one, or more, end-users.

### CROSS-REFERENCE TO RELATED APPLICATIONS

This application claims the benefits of the filing of U.S. Provisional Patent Application Ser. No. 61/618,835 entitled, Common Service Platform and Embedded Revenue Method, filed Apr. 1, 2012 and the specification thereof is incorporated herein by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### TECHNICAL FIELD

The present invention is in the technical field of utility services and in the technical field of digital and analog services. More specifically, the present invention is in the technical field of providing combined utility, digital and/or analog services to one, or more, end-users and the accounting thereof including end-user billing and payment for utility, digital and/or analog services.

### BACKGROUND OF THE INVENTION

Conventional utility delivery is typically achieved through the transmission of gas, electricity or other utility service, through a main distribution line that is stepped-down to serve individual communities and whose distribution line may be stepped-down again until a single delivery line is directed to a single end-user entity such as single-family residence. The single delivery line is also, typically, connected to a meter such that the utility company may gauge consumption of the energy, or other utility, delivered to end-user and charge the end-user. Typically, the utility will charge the end-user on a monthly basis for the amount consumed, as measured by the meter, times the cost per unit consumed and add ancillary charges such as certain fees, taxes, etc.

Conventional delivery of analog and digital services is more varied by comparison to utilities with some services, such as the digital content of some movies, being delivered in a very similar method to that of utilities with a source provided to the end-user, such as through coaxial cable, and through a service entrance, such as a service box, to the house or building. Other digital services may include wireless services, such as cellular handsets, that may not require a service entrance. Billing for such services is different from most utilities in that the digital service provider may, typically, charge the end-user a flat monthly rate that may then also vary for exact content used, or viewed, or that may charge a premium for use of the digital services beyond a defined allotment to end-user. Both approaches typically include some fixed fee amount and a variable amount based on consumption.

Alternatively, the end-user may provide for utility, digital or analog service extension or substitution by the purchase of certain devices and such that end-user may have only the fixed, upfront, fee to purchase the device. A wireless router is an example for digital services, a traditional AM/FM radio for analog services and rain barrels as an alternative to a water utility. In such instances, there is no monthly fee or fee based on consumption.

In nearly all instances of residential, commercial and industrial use, the end-user purchases utilities, and other services, in some combination and, depending on each end-user's unique needs and circumstances, will purchase, rent, lease or otherwise make payment for continued use of such utilities and services and often resulting in the end-user curtailing some service in order to obtain another, more preferred service. Further, in nearly all cases, the various services provided are from separate service providers each with a unique system to support, bill, collect payment from the end-user. The below various patents reflect varying approaches of using systems and platform devices to facilitate end-user, or end-users, payment of services.

U.S. Pat. No. 7,774,245 (Voysey; Aug. 10, 2010) teaches us of a building optimization platform and web-based utility invoicing system. This patent consists, primarily, of a system comprised of an enterprise storage device, telephony services, web services, building controls and invoice generation and approval system. The platform, and resulting method(s) described in this patent provide for the invoicing of utility charges of various tenants within a building and the additional ability to alter the invoice amount for other charges such as use of additional energy above a tenant's lease-defined amount and then the subsequent invoicing of the revised bill. The utility of this patent is various demonstrating the concept of adjusting utility bills for a fixed and variable amount(s) as well as multi-user (tenant) invoicing from one system and the electronic invoicing of service charges.

U.S. Pat. No. 7,720,731 (Ickowicz; May 18, 2010) teaches us of a method and system for leasing and sharing of goods among a group. This patent describes the method of accounting for a set of goods or services, identified to be automobiles, such that an available inventory is defined. The inventory of goods is further defined into individual units such as a single vehicle. A single vehicle and lease term are selected leading to the calculation of lease costs and, on acceptance, the selection of payment method, printed agreement for signature and the storage of information such as storage on a computer. This patent also claims that the pool of vehicles for sub-lease are owned by the lessors. This patent has various utility including the claim for at least one vehicle to be energy efficient. Further, this patent establishes a principle of a common item, such as a vehicle, owned by at least one party and utilized by another party, or parties, under a sub-lease.

U.S. Pat. No. 7,844,499 (Yahiro et al; Nov. 30, 2010) teaches us of an integrated solar agent business model. This patent describes use of a platform, such as a computing system, to manage the multiple steps, and parties, associated with a typical installation of photovoltaic panels for an end-user such as a residential consumer. The steps include, but are not limited to, assessment of energy needs, contacting solar contractor, installation, payment of services, financing and related calculations that may also include the accounting of any associated Renewable Energy Credits. The utility of this patent is multi-fold and works, at least partially, to establish an integrated approach to an existing, if not also fragmented, business model between photovoltaic end-users, installers (contractors), solar panel producers and the financing, and payment, of, and for, the installed solar system.

U.S. Pat. No. 7,810,137 (Harvey et al; Oct. 5, 2010) teaches us of a method of controlling network access that induces consumption of merchant goods or services. This patent describes a method that provides for an end-user to obtain access to a computer network based on an access code wherein the access code is granted on the purchase of a good or service from a merchant associated to the computer network. This patent has obvious utility and helps to identify one approach of associating network connection to the purchase of non-network goods and, or, services.

U.S. Pat. No. 7,890,436 (Kremen; Feb. 15, 2011) teaches us of billing and payment methods and systems enabling equipment on consumer, or end-user, premises. This patent describes a business method that, as claimed, increases the likelihood of repayment of a loan, lease or other financial instrument provided by a lender for the purchase, lease, installation and/or maintenance renewable energy equipment on a consumer's premises. This patent includes the processing of receivable payments from excess energy sold to a utility as well as a method of billing by lender. The utility of this patent is to help provide methods by which additional renewable energy systems can be financed and installed by acting to remove some of the risk associated with financing such projects. This patent relies on more traditional methods of financing such as loans and leases.

### SUMMARY OF THE INVENTION

The present invention is a business method premised on a common service platform system that provides for optional service and billing selections by a service provider, or service aggregator, to primary end-user and third party end-user customers for one, or more, services where such services are utility and digital, or analog, services, such as digital content delivery, wireless, Internet access, or related, and where such utility and services are delivered from a common service platform system that is comprised of an integrated device to provide for delivery and/or measurement of utility consumption plus other, non-utility, services and where utility services include any traditional utility functions including renewable energy sources.

The primary objective of the present invention is to provide an integrated billing method premised on serviced delivered from a common service platform system that can directly provide or facilitate the delivery of multiple services to one, or more, end-users and such that the combination of services can facilitate the delivery of primary utilities, including renewable energy, to primary end-users who may not be able to afford such utilities without some form of financial aid or assistance and where such aid or assistance may be made available through the integrated billing method.

The primary advantage of the present invention is to provide a new service model that allows for the delivery of services to a primary end-user and for the delivery of at least one type of service to third party end-users and thus providing the for novel billing methods, including subsidization by third party end-users of the primary end-user's account, and where such third party subsidization may act as a substitute to governmental, or other, subsidies for certain services such as renewable energy.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

FIG. 1 is a perspective view of a generic common service platform system representing the first part of the present invention;

FIG. 2 is a perspective view of a typical building with various embodiments of common service platform system utilization;

FIG. 3 is a diagram showing the primary steps to process an end-user order, deliver and install a common service platform system and associated data capture and storage;

FIG. 4 is a diagram showing the primary steps for end-user's use of common service platform system and the subsequent accounting for and billing of such services;

FIG. 5 is a diagram showing a summary of primary steps of end-user's use of common service platform system and the subsequent accounting for and billing of such services with additional steps involved for the delivery, accounting and billing of alternative advertising.

### DETAILED DESCRIPTION OF THE INVENTION

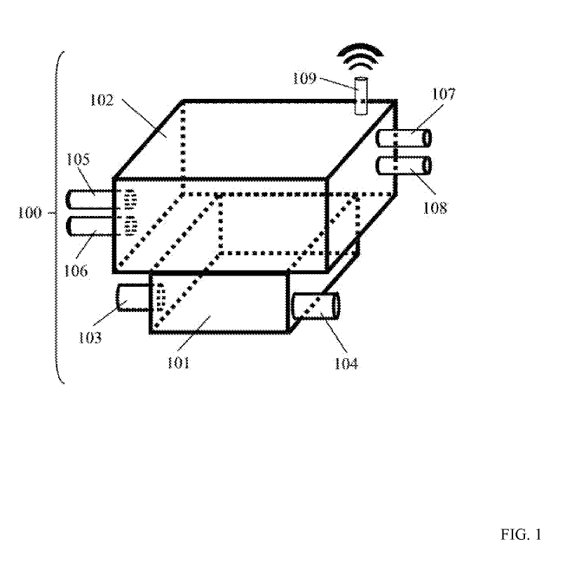

Referring now to the invention in more detail, in FIG. 1 a common service platform system 100 is comprised of two primary subcomponents with the first being a energy generating device or a utility measurement device 101 and the second, service module 102, representing one, or more, digital and, or, analog services to be delivered to one, or more, end-users. It should be understood that device 101 may characterized to be an energy generating device such as a solar panel, or array, or a wind turbine or other co-locatable energy-producing device. Alternatively, device 101 may be a utility measurement device such as an electrical, gas or water meter with the primary concept of device 101 to be a device that receives a utility type input, such as electricity, gas or water, and where that input, such as sunlight for photovoltaic effects or electricity from the grid either meters and, or, acts to transform the input(s) into a usable form for end-user(s). Accordingly, device 101 is comprised to have one, or more, means of receiving an input 103 and at least one means for delivering the output 104. Similarly, service module 102 is also comprised to receive inputs from one, or more, digital or analog services providers and where input receivers are shown as subcomponent 105 and 106 and where these may be understood to be input connections, such as plugs, USB ports, or similar, and that represent different digital and, or, analog services. Service module 102 is further shown to have output subcomponents 107 and 108 and where it may be understood that these may also be plugs, cords, USB ports, or other means to output digital and, or, analog services and that may be associated to the same services provider inputs received through input subcomponents 105 and 106. Additionally, service module 102 is shown with wireless output antenna 109.

For the purposes of understanding, input devices 105 and 106 may be wired or wireless and output devices 107 and 108 may be wired or wireless. Further, that the primary purpose of service module 102 is to provide one, or more, co-located digital or analog services such as radio signal, television signal, Internet communication or other service(s) to one, or more, end-users.

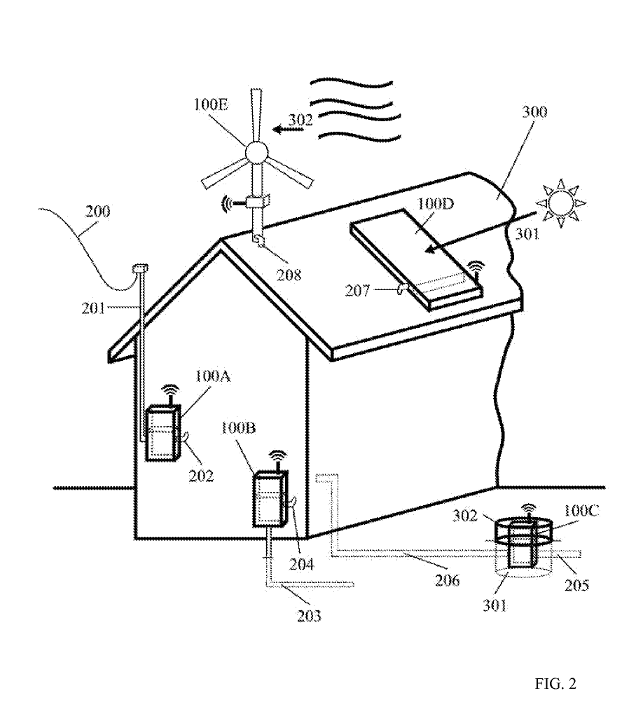

Referring now to FIG. 2, a typical building 300, such as a house, is shown with different representations of common service platform system 100, as comprised by the description in FIG. 1, that is demonstrated with different energy device 101 alternatives and as explained by the following. Common service platform system 100A is comprised of a typical electric meter and service module. Common service platform system 100A is connected via utility pole 201 to utility electrical wire 200 to represent main power. Electrical output to building 300 is provided by connection 202. Common service platform system 100B is comprised of a gas meter, such as natural gas, and a service module. Gas is provided to the common service platform system 100B through input pipe 203 and gas is delivered from the common service platform system 100B to building 300 through output connection 204. Common service platform system 100C is comprised of a water meter and service module that are located in ground recess 301 that represents a typical position for water utility service(s). Common service platform system 100C receives the input of water through pipe 205 and provides the output of water to building 300 through pipe 206. The whole of common service platform system 100C is covered by cover 302 and that may be understood to be a protective cover with a hard shell and optional insulation. Common service platform system 100D is comprised of a photovoltaic panel and service module and where it should be understood that the photovoltaic panel may represent one, or more, such panels. Sunlight 301 strikes the photovoltaic portion of common service platform system 100D as the input. The output of electricity is provided by connection 207. Common service platform system 100E is comprised of an electricity generating wind turbine and service module. Wind 302 provides the input to turbine. The output of electricity from the common service platform system is provided by connection 208.

In further reference to FIG. 2, it should be understood that for each representation of the common service platform system, 100A-100E, the various methods of input and output from the service module for the one, or more, digital and, or, analog services are not shown in FIG. 2 and for the purposes of illustration of the other, utility-related, components. Each representation of common service platform system 100A-100E should be understood to have one, or more, input and output subcomponents for digital and, or, analog, services as explained in FIG. 1 and to include wireless input and/or output subcomponents.

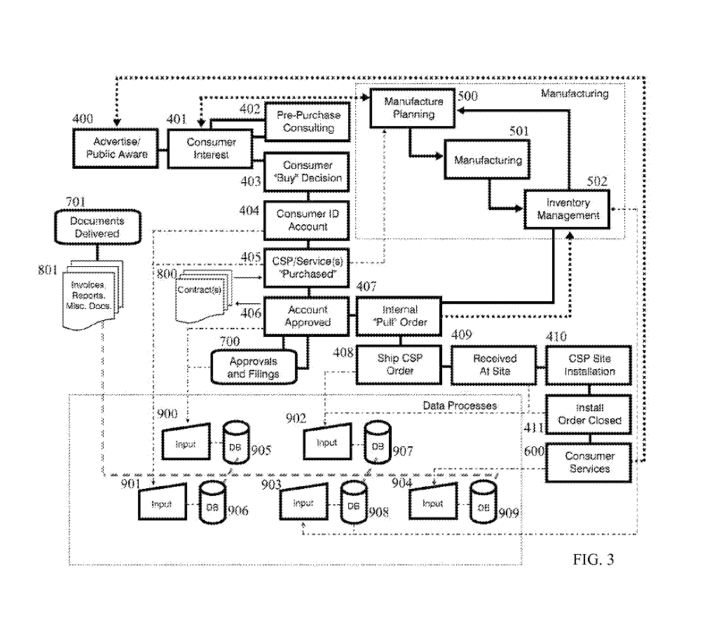

Now referring to FIG. 3, a method is explained for an end-user consumer to be made aware of the present invention of the common service platform system with subsequent order, account set up, delivery and installation. This method is described by primary steps 400-411, primary manufacturing steps 500-502, alternative steps 700-701, documents 800-801, data input and storage steps 900-909 with these combined and inter-related steps, documents and technologies resulting in the commencement of consumer services 600. Specifically, in step 400 the general public is made aware of the common service platform system and its co-located services. An individual consumer expresses interest in step 401 and may contact seller, or seller's agent, to consult on merits of common service platform system in step 402. Consumer choosing to purchase the common service platform system and related utilities/services makes such decision in step 403 and contacts seller who then creates a customer profile and account number in step 404. This information is input, by various means such as direct input via step 901 or customer input from a web-page, to database 906. The next process step is for the consumer to actually “purchase” the common service platform system and related services and this is shown as step 405.

Step 405 is critical for understanding the present invention. It represents the step of contractual commitment between the seller and consumer or primary end-user. It also defines the initial state and definition of the type of utility and available digital and analog services co-located with utility device and noting that different combinations of utility and services will be desired from different end-users. As such, step 405 provides for the customization of production units for specific end-user needs. Step 405 is also critical for understanding the type of embedded revenue model that is part of the present invention. Namely, that seller and end-user make agreement for not only the utility and service provided but also the cost, charges, fees and other elements of revenue to seller that may be charged to end-user at the time of this transaction or over time to end-user and through such means as a lease, monthly usage, power purchase agreement, easement or other form of agreement. Step 405 is also critical in understanding the present invention for the combination of digital, and, or, analog services that may be utilized by unrelated third parties and in such manner that seller gains rights from the primary end-user to utilize portions of the common service platform system, and space on which the common service platform system rests, to deliver such services to one, or more, third parties and thus allowing seller to gain the benefit of additional revenue streams from those third party users in addition to any revenue stream from the primary end-user. Further, that seller has the option to provide primary end-user rebates, credits, subsidies or other offsets to the primary end-user's billing and such that end-user may gain benefit from such arrangement. Such agreement is manifested by contract(s) 800 and optional approval step 700 resulting in approved contract, step 406.

Once approved, the primary end-user's order needs to be fulfilled and this is begun at step 407. Step 407 is connected to the seller's manufacturing steps and that should be understood to be any combination of internal and external manufacturing steps resulting in the common service platform system with functional utility and services. In simplified form, step 407 reduces inventory, and the management thereof, at step 502. Inventory levels are feed to step 500 for manufacturing planning that then feeds to step 501 of manufacturing, that, itself, may be represented by multiple entities, and back to finished inventory 502. Once the inventory is pulled it can be shipped at step 408 and received at a field office and then delivered to primary end-user or shipped directly to primary end-user's location, both options resulting in step 409. The common service platform system is installed at step 410 at primary end-user's location and all ordered services initiated. Successful installation is confirmed at step 411 that leads to the start of ongoing consumer services or step 600.

Finally, the method to achieve order and installation of common service platform system requires use of at least one computer and database that are reflected in FIG. 3 as input steps and related databases 900-909 and that are shown to be inter-related to provide improved data management and other documents 801 with alternate process step 701 to send documents 801.

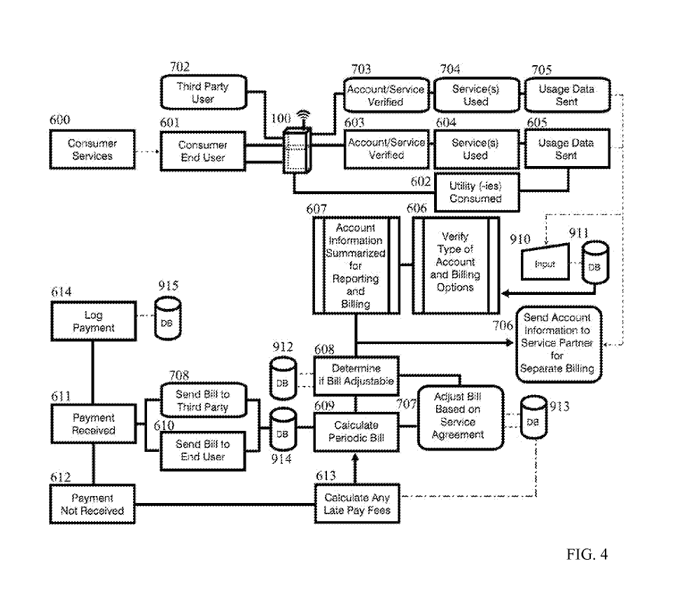

Now referring to FIG. 4, step 600 for ongoing consumer, or end-user, services is described and starting with step 601 representing the primary end-user utilizing common service platform system 100 in the two primary ways of utility consumption 602 and through use of digital, and, or, analog services that requires verification of the account and services defined by agreement and shown as step 603 followed by use of service(s), by means of an end-user service device, at step 604. Usage of digital and, or, analog services data and utilities by primary end-user is then sent to seller or related parties at step 605 and that may include revenue-sharing information between primary end-user and seller. Alternate step 703-705 demonstrate how a third party end-user 702 can make use of one, or more, digital and, or, analog services from common service platform system 100 and wherein use of services requires a step to verification of the account and services defined by agreement, step 703, followed by use of service(s), by means of an end-user service device, at step 704. Usage of digital and, or, analog services data by third party end-user is then sent to seller or related parties at step 705 and that may include revenue-sharing information between primary end-user and seller. When usage data is sent to seller, or agent, data is sent to input step 910 that may be understood to be means of electronic data transfer that is stored in database 911. From database 911, account information is verified at step 606 and summarized, per end-users' agreements, at step 607. Each end-user's bill is either transferred to seller's partners at step 706 or determined to be adjustable for various factors including rebate or credit provided by use of third parties of common service platform system at step 608 and optional step 707. Step 706 should be understood to also be inclusive of a billing method from seller to other service providers, in addition to other data shared, and to provide for any optional seller's revenue share program with primary end-user, such as energy-creation re-selling, or other revenue share programs between service provider to other service providers. Step 608 utilizes database 912 and step 707 utilizes database 913. Next, the periodic bill is calculated at step 609 and sent for storage in database 914. From database 914, primary end-user can be billed directly at step 610 and third party end-user(s) can be directly billed at alternate step 708. From steps 610 and 708 seller may receive payment at step 611 and log payment at step 614 and into database 915. If end-users do not make payment via step 612 their respective bills may be subject to late payment penalties and fees calculated at step 613 whose resulting calculations can be tallied in subsequent period(s) total bill calculation at step 609.

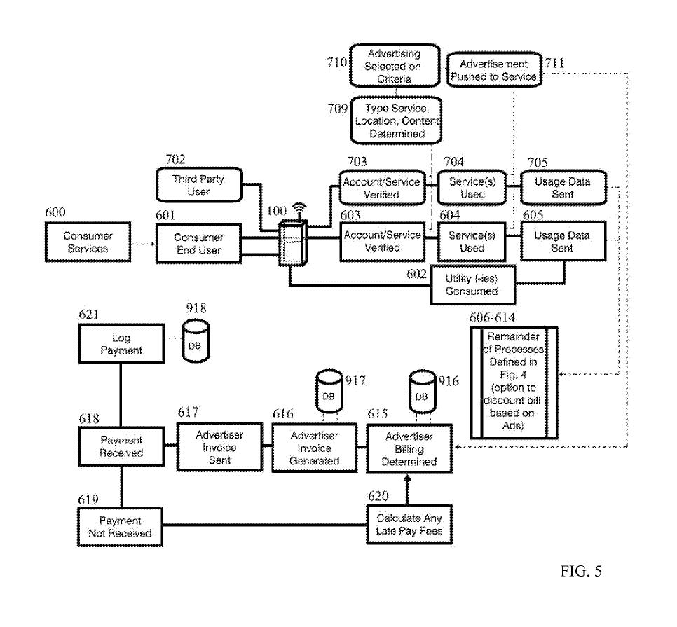

Now referring to FIG. 5, step 600 for ongoing consumer, or end-user, services is described and starting with step 601 representing the primary end-user utilizing common service platform system 100 in the two primary ways of utility consumption 602 and through use of digital, and, or, analog services that requires step 603 to verify the account and services defined by agreement followed by use of service(s), by means of an end-user service device, at step 604. Usage of digital and, or, analog services data and utilities by primary end-user is then sent to seller or related parties at step 605 and that may include revenue-sharing information between primary end-user and seller. Alternate step 703-705 demonstrate how a third party end-user 702 can make use of one, or more, digital and, or, analog services from common service platform system 100 and wherein use of services requires step 703 to verify the account and services defined by agreement followed by use of service(s), by means of an end-user service device, at step 704. Usage of digital and, or, analog services data by third party end-user is then sent to seller or related parties at step 705. For the purposes of explanation, input and database steps 910-915 and steps 606-614, as explained in FIG. 4, are summarized as step 606-614. Additional elements to explain the optional advertising steps include step 709 which is to provide for the alternative step of determining the type and, or, location, and, or, content of digital, and, or analog, service being delivered from common service platform system 100 and for the purposes of determining an appropriate advertising content for delivery that is shown as step 710 and where the appropriate criteria may be determined from a separate process. Once advertising content is determined, it can be pushed, through electronic means, to receiving end-user(s) at step 711. The act, or event, of user receiving advertising content may be considered a revenue-bearing event requiring documentation of the event and relevant attributes of that event. Such transmission of data is sent to seller also at step 711 after which the advertiser's billable rate, or other terms, are calculated at step 615 and such data is stored in database 916. Afterward an invoice is generated at step 616, stored in database 917 and then sent to advertiser at step 617. Payment from advertiser is received at step 618 and logged at step 621 and stored in database 918. In the event payment is not received, step 619, a late payment fee, or fees, may be calculated at step 620 and added to the next periodic bill at step 615.

The advantages of the present invention include, without limitation, the ability to provide combined electricity, or other utility, and digital and/or analog services to a primary end-user and provide to unrelated third party users digital and/or analog services from a common service platform system and the related, integrated, billing of such services, including advertising revenue, to allow for the rebate, credit, subsidy or other payment benefit of the primary end-user.

In broad embodiment, the present invention is a revenue business method that relies on a device and where the device combines the creation of electricity through renewable means, or the measurement and metering of utilities, with at least one digital and/or analog service to form a common service platform system and where at least one digital and/or analog service is wireless and made available to third party end users and in such a manner that use of the delivered electricity, other utility, and any digital and/or analog services may be billed to the end-users of the common service platform system through the revenue business method.

### DESCRIPTION OF THE PREFERRED EMBODIMENTS (BEST MODES FOR CARRYING OUT THE INVENTION)

The present invention may be used as a method for gaining revenue from the delivery of utility-related services and the delivery of digital and/or analog, non-utility, services through a common service platform system.

As a preferred embodiment, the present invention is a revenue method providing for multiple revenue streams from the second part of the present invention, a common service platform system, and where that common service platform system provides multiple services for a primary end-user and multiple third party end-users. In its preferred embodiment, the present invention's common service platform system is segregated into two basic components the first of which is utilized for the generation of renewable energy through solar panels and the second of which is used to contain digital and/or analog electronic boards that may provide for multiple digital and/or analog services or combination of services.

The present invention may be utilized as a substitute to and improvement over current methods of billing end users for various services by providing for an integrated bill and/or account statement while, more so, also acting to provide greater utility as a substitute and improvement for both the government-subsidy based installment of renewable energies, by using the common service platform system and revenue method to create a new subsidy to the primary end-user, and for wireless carriers, such as telecommunications and satellite companies, to provide greater service to multiple end-users through the wireless service nodes contained within the common service platform system and where such nodes may include, but are not limited to, wireless routers, femtocells and/or picocells and that may be thought of as service extenders for wireless coverage and delivery of service and/or content. Further, the common service platform system component of the present invention may also be utilized as a substitute to and improvement over other devices such as digital media storage.

### INDUSTRIAL APPLICABILITY

The invention is further illustrated by the following non-limiting examples.

### EXAMPLE 1

The present invention may act as a method to generate revenue gained through the successful delivery of utility-related services and wireless extended coverage to only the primary end-user. In this example, the revenue method provides for revenue gained through the monthly billing of electricity generated from a roof-mounted solar array and where such array contains at least one solar panel affixed with a femtocell and where such femtocell may be further connected to a high speed Internet connection already present at the primary end-user's residence.

The present invention provides for the configuration of the solar panel solution and the mounting of at least one additional service to a solar panel to create the common service platform system. The present invention also provides for alternative billing of the services provided to the primary end-user.

Under typical circumstances, and prior to the order of the common service platform system, the primary end-user may be dependent on main power at an average cost of $130 per month. Because of the location of the primary end-user's residence, the primary end-user has also determined she would enjoy the benefit of a wireless network extender at a fixed, one-time, cost of $225. In a year, the primary end-user will spend $1,560 for main electricity and another $225 for the network extender for a total of $1,785.

By contrast, by ordering the common service platform system, the primary end-user can opt for a Power Purchase Agreement, or PPA, to purchase the electricity generated from the solar panel array at a monthly rate of $115 and also sell back to the main power company another $10 per month. Additionally, because the service provider integrated the femtocell network extender to a solar panel, the service provider can increase the monthly charge to the primary end-user from $115 to $118 per month with the additional three dollars attributed to the cost of the network extender. Now, the primary end-user, in the same year, may spend a total of $1,416 for both services while also receiving a revenue for selling excess electricity of $120 per year thus reducing the cost of both services from $1,416 to $1,296 and that represents an over 27% reduction from the first year cost of $1,785 without the common service platform system and embedded revenue method.

### EXAMPLE 2

The present invention may act as a method to generate revenue gained through the successful delivery of utility-related services and the successful delivery of multiple non-utility services to multiple end-users.

The primary end-user, a home owner, selects the present invention to provide for the generation of electricity from solar panels and additionally opts to gain increased WiFi coverage, a wireless network extender and 500 GB of digital media storage. Because of the location of the primary end-user's residence, in a high traffic area, the service provider opts to add to the definition of the common service platform system a picocell for longer-range wireless coverage. Service provider opts to request and gain the right to place this additional equipment within the definition of the common service platform system from primary end-user and by providing an economic incentive for the primary end-user to grant such rights to seller and service provider.

Under the unadjusted terms of the Power Purchase Agreement, similar to that in Example One, the primary end-user will pay $115 per month to the service provider for electricity but also gain a $10 revenue from the main power company. Additionally, the primary-end user will pay an additional $3.00 per month for the wireless network extender, $1.00 per month for expanded WiFi and $30.00 per month for the digital media storage where cloud-based services may normally cost $50.00 per month. All the services, unadjusted, are to be billed at $149 per month. However, the economic incentive provided to the primary end-user to grant use of the picocell for third-party use by the service provider is a reduction of $4.00 per month from the non-electrical bill for a total, integrated, monthly bill of $145 as determined through the revenue method.

From the service provider's point of view, in addition to the $145 per month gained from the primary end-user, the service provider may lease the picocell to a wireless service provider for $10.00 per month offsetting the discounted $4.00 per month and resulting in a combined, total, revenue from the one common service platform system of $155 per month. The wireless service provider then utilizes the picocell as a node in its extended network and makes the node connection available to its multiple subscribers in the area.

### EXAMPLE 3

The present invention may act as a method to generate revenue gained through the successful delivery of utility-related services and the successful delivery of multiple non-utility services to multiple end-users.

The primary end-user, a home owner, selects the present invention to provide for the generation of electricity from solar panels and additionally opts to gain increased WiFi coverage, a wireless network extender and 500 GB of digital media storage. Because of the location of the primary end-user's residence, in a congested area with many pedestrians, service provider opts to add to the definition of the common service platform system a second multi-channel wireless router with wireless Internet connection for use by passerby pedestrians. Service provider opts to request and gain the right to place this additional equipment within the definition of the common service platform system from primary end-user and by providing an economic incentive for the primary end-user to grant such rights to seller and service provider.

Under the unadjusted terms of the Power Purchase Agreement, similar to that in Example One and Example Two, the primary end-user will pay $115 per month to the service provider for electricity but also gain a $10 revenue from the main power company. Additionally, the primary-end user will pay an additional $3.00 per month for the wireless network extender, $1.00 per month for expanded WiFi and $30.00 per month for the digital media storage where cloud-based services may normally cost $50.00 per month. All the services, unadjusted, are to be billed at $149 per month. However, the economic incentive provided to the primary end-user to grant use of the second wireless router for third-party use by the service provider is a reduction of $4.00 per month from the non-electrical bill for a total, integrated, monthly bill of $145 as determined through the revenue methodology.

From the service provider's point of view, in addition to the $145 per month gained from the primary end-user, the service provider may, through other means, provide access to the WiFi hotspot to numerous passerby pedestrians throughout the month by a either subscription fee and/or advertising. For non-subscriber users, the identity of the service provider's hotspot would be recognized and access through the hotspot granted to the user for viewing an advertisement(s). The advertisement may be for any company but may also be provided for local, near-to-the-user, destinations such as restaurants.

During the course of a month, an average of 100 people utilize the hotspot per day and resulting in 3,000 views of the advertisement that is displayed before login. Internet advertising is charged on a Cost per Mill (CPM) or cost per one thousand impressions. CPM rates vary with food-related CPMS rates ranging from $2/CPM to over $6/CPM. The service provider gains an average rate of $4/CPM by the three CPMs (or 3,000 impressions) for a total monthly revenue from advertising of $12. The total, combined, revenue gained by service provider under this example is $157 per month. All revenue is tracked, billed and recognized through the revenue method.

The preceding examples can be repeated with similar success by substituting the generically or specifically described parameters and/or operating conditions of this invention for those used in the preceding examples.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A common service platform system comprised of at least one electrical utility metering device and at least one electronic device that provides at least one wired or wireless, non-utility related, digital service to at least one end-user and where common service platform is configured to meter the electrical utility service and to separately deliver digital content, data, media or access to end-user(s);

2. A common service platform system comprised of at least one non-electrical utility metering device and at least one electronic device that provides at least one wired or wireless, non-utility related, digital service to at least one end-user and where common service platform is configured to meter the non-electrical utility service and to separately deliver digital content, data, media or access to end-user(s);

3. A common service platform system comprised of at least one electricity generating device and at least one electronic device that provides at least one wired or wireless, non-electricity related, digital service to at least one end-user and where common service platform is configured to generate and deliver and meter electricity and to separately deliver digital content, data, media or access to end-user(s);

4. A method of identifying, segregating and delivering an integrated invoice to at least one end-user for services provided from the common service platform system, as claimed in claims 1-3, comprised of a computer-based system to register service usage of each service type and apply fixed and/or variable rates to each applicable end-user account including reduction in end-user's account and where such computer-based system is comprised of at least one database, one software application to calculate billing and that has the means to print and deliver or electronically deliver integrated bill to end-user(s) and register end-user's payment and, as necessary, calculate end-user late payment fees;

5. A method of providing to at least one third party service provider end-user service account usage attributes from one, or more, common service platforms systems, as claimed in claims 1-3, comprised of at least one database, one software application to calculate end-user information by account and that has the means to print and deliver or electronically deliver correct end-users' information to at least one third party service provider;

6. A method to purchase, rent, lease, sub-lease, gain easement rights or otherwise gain contractual rights to physical space controlled by a primary end-user for the purposes of locating at least one common service platform system, as claimed in claims 1-3, that is comprised of a printed or online written agreement between primary end-user and primary service provider or designee(s);

7. A method for primary service provider to provide on-demand or directed content to at least one end-user through the common service platform system, as claimed in claims 1-3, that is comprised of a computer-based system and at least one software application to deliver content to end-users and to account for the delivery of content for the purposes of tracking, reporting and billing to third parties.
